(19) United States
(12) Patent Application Publication
(10) Pub. No.: US 2024/0351143 A1
(43) Pub. Date: Oct. 24, 2024

(54) PROCESSING DEVICE AND METHOD FOR PROCESSING FLAT MATERIAL

(71) Applicant: SCHUNK Electronic Solutions GmbH, St. Georgen (DE)

(72) Inventors: Sven Flaig, Niedereschach (DE); Mattias Kiebe, Tuttlingen (DE); Stefan Ringwald, Elzach (DE)

(21) Appl. No.: 18/640,460

(22) Filed: Apr. 19, 2024

(30) Foreign Application Priority Data
Apr. 21, 2023 (DE) 10 2023 110 266.4

(51) Int. Cl. B23K 26/38; B23K 26/40; B23K 37/04; B23K 101/18

(52) U.S. Cl. CPC B23K 26/38; B23K 26/40; B23K 37/0408; B23K 2101/18

(57) ABSTRACT

A processing device (10) for processing flat material (12) extending along a material plane (11) includes at least one holding device (200) for holding the flat material (12), at least one clamping device (400) for fastening the flat material (12) in place and for clamping the flat material (12) along the material plane (11), and at least one laser device (600) for cutting at least one cut piece (1) from the flat material (12). The holding device (200) is designed such that the at least one cut piece (1) is held by the holding device (200) after the laser cut.

### BACKGROUND

This disclosure relates to a processing device and to a method for processing flat material.

### SUMMARY

Flat materials, in particular anode and cathode foils, are required in the electronics industry and in particular in the production of accumulators for e-mobility.

For the purposes of this application, flat materials are to be understood as single- or multi-ply layers or foils, wherein the layers or foils have a substantially greater longitudinal and transverse extent than a thickness. Furthermore, the flat material is designed to be flexible, so that without support the flat material deviates substantially from a flat shape over the longitudinal and transverse extent. Furthermore, the flat material is at least substantially impermeable to gas, so that the flat material can be held by suction. Furthermore, the flat material or its layers is of monolithic design. The flat materials can in particular comprise plastic or metal, wherein metal-coated plastics or plastic-coated metals are also conceivable. The flat material can be designed as a flat material strip portion. The flat material can be, for example, a busbar foil with the dimensions 200 mm×280 mm, wherein the foil comprises graphite and is coated with aluminum or copper.

The handling, fastening and processing of such flat materials, in particular the production of cut pieces from the flat material, are complex due to the thinness and flexibility of the flat material.

The flat material represents a semi-finished product, from which at least one cut piece is produced. The cut pieces have the outer contour required for the use case and are designed smaller than the flat material with respect to the longitudinal and transverse extent. The remaining part of the flat material that is not associated with the cut pieces is referred to as waste.

Accordingly, the object of this disclosure is to produce a cut piece made of a flat material securely, reliably and reproducibly.

The object of this disclosure is achieved by a processing device for processing flat material extending along a material plane having the features of claim 1. The processing device has at least one holding device for holding the flat material, at least one clamping device, in particular designed separately from the holding device, for fastening the flat material in place and for clamping the flat material along the material plane. The clamping is intended to build up an internal tension, which extends in the material plane, within the flat material, wherein the clamping should counteract the flexible design of the flat material. The flat material should thus be able to be reliably processed and in particular undesired distortions or overlaps in the flat material should be prevented.

In addition, at least one laser device for cutting at least one cut piece from the flat material is provided. In the processing state, the material plane of the flat material extends along an x-axis (longitudinal extent) and along a y-axis (transverse extent), wherein the thickness of the flat material runs along a z-axis running perpendicular to the material plane. The laser device is configured such that a laser beam emitted by the laser device is directed onto the flat material and an energy input into the flat material occurs at an impingement point, so that the flat material is cut at the impingement point. The laser device is configured such that the laser beam can be moved over a working region which extends over a substantial part of the flat material. During cutting, the laser can travel the entire contour of the cut piece or alternatively only travel a substantial part of the contour of the cut piece, wherein the non-cut part then has to be separated in a different manner in order to completely release the cut piece from the waste. Due to the cutting of the flat material, there is no mechanical load on the flat material, such as during cutting, sawing or punching. The thermal load is negligible. It is conceivable that, in order to protect the surroundings of the surrounding components, laser protection is provided which surrounds the working region of the laser beam and counteracts a reflection of the laser beam.

Furthermore, the holding device is designed such that, after the laser cut, i.e., after the cut piece and the waste or the layers thereof are no longer monolithic, at least the cut piece is held by the holding device. Accordingly, despite laser cutting, the cut piece still remains in a defined position, so that the subsequent gripping and removal is enabled or facilitated.

The holding device is preferably designed as a vacuum holding device for suctioning the flat material. The holding device advantageously has nozzles for forming the vacuum. The nozzles are arranged such that the nozzles suction the flat material and in particular the cut pieces. The holding device is preferably designed such that the flat material can be placed onto the holding device. In this case, the flat material is suctioned from below and thus held in a defined position.

Furthermore, it is conceivable that the holding and/or the clamping device are accessible from above, so that the flat material can be placed from above onto the holding device and/or into the clamping device. The laser beam direction is directed from the laser device to the holding device. Accordingly, “from above” means coming from the direction of the laser device or directed in the laser beam direction.

It is advantageous if the clamping device has at least two opposite pairs of clamping jaws for fastening in place and/or for clamping one side of the flat material in each case. The clamping device is preferably designed such that a first side of the flat material can be gripped by means of the first pair of clamping jaws and a second side of the flat material can be gripped by means of the second pair of clamping jaws. In the clamped state, the flat material is arranged between the pairs of clamping jaws. The clamping device and/or the clamping jaws are designed such that, when the flat material is fastened in place, the flat material is simultaneously clamped and/or such that, after being fastened in place, the clamping jaws are displaced away from the flat material along the x-axis in order to achieve a tensioning of the flat material. The clamping device, in particular the pairs of clamping jaws, are preferably arranged outside the working region of the laser device, so that the laser beam only moves between the clamping devices.

An advantageous development of this disclosure provides that the laser device can be displaced at least along the x-axis and the y-axis. The x-axis and the y-axis run parallel to the material plane when the flat material is fixed in the clamping device and/or is placed on the holding device. It is also conceivable for the laser device to be displaceable along the z-axis, i.e., perpendicular to the material axis. Accordingly, the at least the greater part of the flat material can be processed by the laser device.

A transport device for handling the flat material is preferably provided. The transport device is preferably configured to provide the flat material on the holding and/or clamping device. The transport device is furthermore preferably configured to grip or remove the cut piece and/or the waste on the holding and/or clamping device. Accordingly, the flat material, the cut piece and/or the waste can be handled reliably and repeatably before and after the laser cutting.

It is advantageous if the transport device has a first handling device, in particular in the form of a robot arm, with a first gripping tool. The first gripping tool is preferably designed as a vacuum gripping tool. The first handling device serves to provide a flat material on the holding and/or clamping device, in that the flat material is placed onto the holding device and is then fixed by the clamping device. For handling the flat material, a vacuum can be provided at the first gripping tool which suctions the flat material onto the first handling device. In order to release the flat material from the first handling device, in particular during the placement onto the holding device, the vacuum can be switched off and an overpressure or air surge can preferably additionally be generated. Furthermore, the first handling device serves to remove the at least one cut piece from the holding device.

It is also advantageous if the transport device has a second handling device designed separately from the first handling device, in particular in the form of a SCARA robot arm, with a second gripping tool. The second gripping tool is preferably designed as a vacuum gripping tool. The second handling device serves to remove the waste from the holding and/or clamping device, provides a vacuum at the second gripping tool which suctions the waste onto the second handling device. In order to release the waste from the second handling device, in particular during the placement onto the holding device, the vacuum can be switched off and an overpressure or air surge can preferably additionally be generated. The second handling device can remove the waste after the laser cutting, so that the first handling device can pick up the at least one cut piece using the first gripping tool. Accordingly, the first handling device, with the first gripping tool, can provide both the flat material and the at least one cut piece. Alternatively, the transport device can have only a single handling device with two different gripping tools, wherein the gripping tools must be changed to remove the waste and the cut piece. Furthermore, the different gripping tools can also be arranged at the same time on a handling device.

An advantageous development provides that the second handling device or the second gripping tool has handling elements, in particular nozzles. The handling elements are arranged such that the handling elements only grip the waste. The at least one cut piece thus remains on the holding device. It is also advantageous if the handling elements are arranged such that the handling elements grip the waste in the region of the pairs of clamping jaws. By gripping the waste in the region of the first side and the second side of the flat material, it can be ensured that the at least one cut piece is not displaced. Furthermore, the waste can thus be released from the clamping device and still remains securely gripped on the second handling device.

An advantageous development of this disclosure provides that a magazine with magazine spaces is provided. Each magazine space has a clamping device and a holding device. Accordingly, a flat material can be accommodated at each magazine space.

The magazine is preferably mounted so as to be rotatable such that the magazine can be rotated about a magazine axis. The magazine is rotatable such that at least one magazine space is arranged in at least one processing position and at least one magazine space can be arranged in at least one loading position. If a first magazine space is arranged in the processing position, the holding and/or clamping device is arranged below the laser device. A flat material accommodated in the first magazine space can thus be processed by means of the laser device. Furthermore, a flat material can thus simultaneously be processed in the first magazine space by means of the laser device, while the waste and the cut piece can be removed from a second magazine space in the loading position and the second magazine space can then be fitted with a further flat material. Accordingly, the set-up times can be reduced.

It is also advantageous if a container for receiving the waste of the flat material is provided in the loading position. When the second magazine space is arranged in the loading position, the container is arranged below the holding device. Accordingly, the waste can be easily and quickly removed and discarded. If the second magazine space at least partially covers the container in the loading position, the second magazine space can be rotated in an intermediate position so that the container is exposed.

It is also conceivable for at least one sensor device to be provided which is configured to detect whether a flat material is provided on the holding and/or clamping device and/or whether the flat material and/or the cut piece and/or the waste is in a suitable position for processing or gripping.

The object of this disclosure is further achieved by a method for processing flat material extending along a material plane having the features of claim 12. The method comprises the following steps: first, a flat material is provided by placing the flat material on a holding device. The holding device is activated and fixes the flat material. The flat material is then fastened in place and clamped by means of a clamping device. An internal tension acting along the material plane is thus built up, which counteracts distortions or overlaps. Since the flat material is initially held and then clamped, it can be ensured that the flat material is in a defined position during clamping. At least one cut piece is then cut from the clamped flat material by means of a laser beam. Consequently, a gentle and precise cutting of the cut piece from the flat material takes place. During laser cutting and after laser cutting, the waste is fixed and clamped by means of the clamping device. During laser cutting and after laser cutting, the at least one cut piece is held by the holding device. It is thus ensured that the cut piece remains in a defined position even after being completely detached from the waste.

It is advantageous if the flat material and/or the cut piece is held by means of vacuum.

It is further advantageous if the flat material is raised by the holding device during clamping. The holding device, in particular the vacuum, can thus be temporarily deactivated. The holding device can be switched on again shortly before or as soon as at least one cut piece has been completely detached from the flat material.

Preferably, after the cut piece has been cut from the flat material, the cut piece is gripped and removed by means of a first handling device.

Preferably, after the cut piece has been cut from the flat material, the waste of the flat material is released, and gripped and removed by means of a second handling device.

It is advantageous if, after the cut piece has been cut from the flat material, first the waste and then the cut piece are gripped and removed. Thus, the same handling device that is used to provide the flat material can be used to remove the cut piece.

It is further advantageous if the method according to this disclosure is carried out by means of a processing device according to this disclosure.

Further details and advantageous embodiments of this disclosure can be found in the following description, on the basis of which an exemplary embodiment of this disclosure is described and explained in more detail.

### BRIEF DESCRIPTION OF THE DRAWINGS

FIG. 1 shows a perspective view of a processing device according to this disclosure;

FIG. 2 shows a perspective detailed view of the processing device in accordance with FIG. 1 with a focus on a magazine;

FIG. 3 shows a perspective view of a magazine according to this disclosure;

FIG. 4 shows a plan view of the magazine in accordance with FIG. 3;

FIG. 5 shows a perspective detailed view of the processing device in accordance with FIG. 1 with a focus on a magazine space in a loading position;

FIG. 6 shows a perspective view of a first holding device according to this disclosure;

FIG. 7a shows a perspective view of a second holding device according to this disclosure;

FIG. 7b shows a schematic plan view of a flat material with the movement path of the laser beam and the vacuum devices and support modules used;

FIG. 8 shows a perspective view of a pair of clamping jaws of a clamping device according to this disclosure;

FIG. 9 shows a side view of the pair of clamping jaws in accordance with FIG. 8;

FIG. 10 shows a perspective upper view of a second handling device according to this disclosure;

FIG. 11 shows a perspective bottom view of the second handling device in accordance with FIG. 10; and

FIG. 12 shows a schematic representation of the steps of the method according to this disclosure.

### DETAILED DESCRIPTION

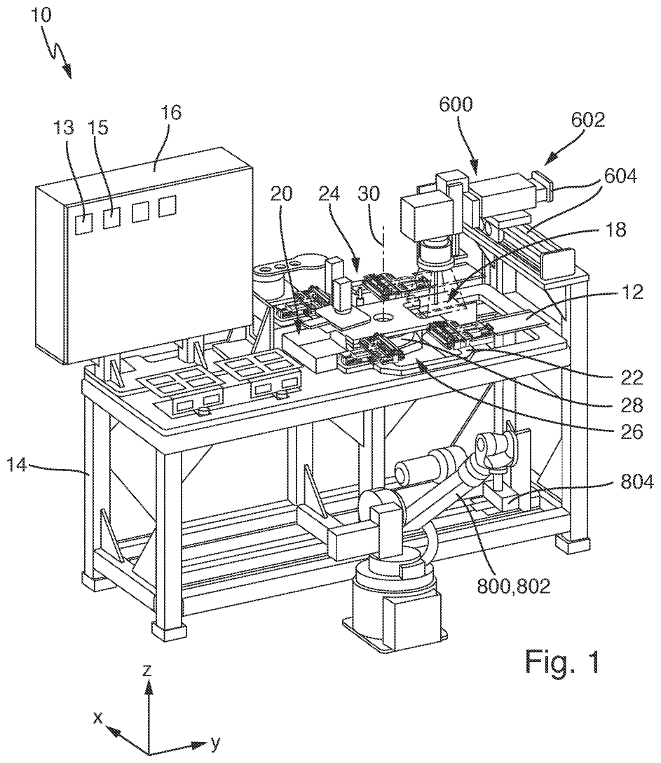

The processing device 10 shown in FIGS. 1, 2 and 5 serves to process flat materials 12 which extend along a material plane 11 and are in particular flexible and substantially impermeable to gas. Such flat materials 12 are, for example, paper or foils. The flat materials 12 can be of single-layer and multi-layer design, wherein the base material and/or the coating material can be made of plastic or metal. In particular for battery manufacturing, foils having a base material based on graphite and with a coating material based on copper or aluminum are to be manufactured. Due to the small thickness and flexible properties of the flat material 12, special requirements are placed on the processing device 10.

In accordance with FIG. 1, the processing device 10 has a device housing 14 and a control cabinet 16. In the device housing 14, the processing device 10 has a processing region 18 and a loading region 20. Furthermore, the processing device 10 has an x-axis X, a y-axis Y running perpendicular to the x-axis X, and a Z-axis Z running perpendicular to the x- and y-axes. In the loaded state, the material plane 11 of the flat material 12 runs parallel to the x-axis and the y-axis.

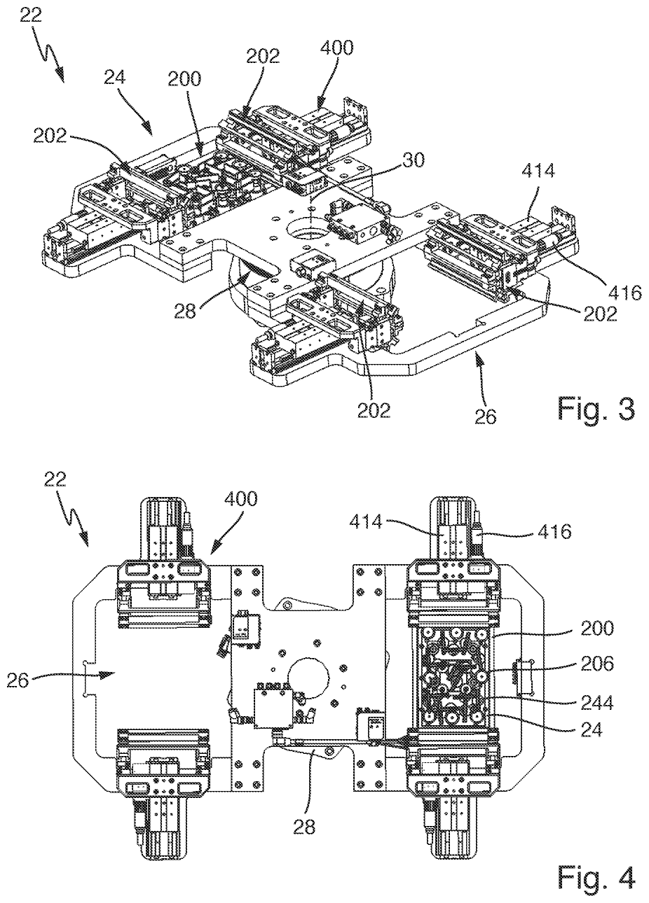

In accordance with FIGS. 1-5, the processing device 10 has a magazine 22 with a first magazine space 24 and a second magazine space 26. The magazine 22 can be rotated about a magazine axis 30 running parallel to the z-axis by means of a rotary drive 28, so that in each case one magazine space 24, 26 can be pivoted in a processing position into the processing region 18 and the other magazine space 24, 26 can be pivoted into a loading position into the loading region 20. The processing position and the loading position are arranged opposite one another along the y-axis. Furthermore, the magazine 22 can be rotated such that both the first magazine space 24 and the second magazine space 26 can be pivoted outside of the processing region 18 and outside of the loading region 20 in an intermediate position.

Each magazine space 24, 26 has a holding device 200 and a clamping device 400. Accordingly, the holding device 200 and the clamping device 400 are pivoted with the associated magazine space 24, 26 into the processing position, the loading position or intermediate position.

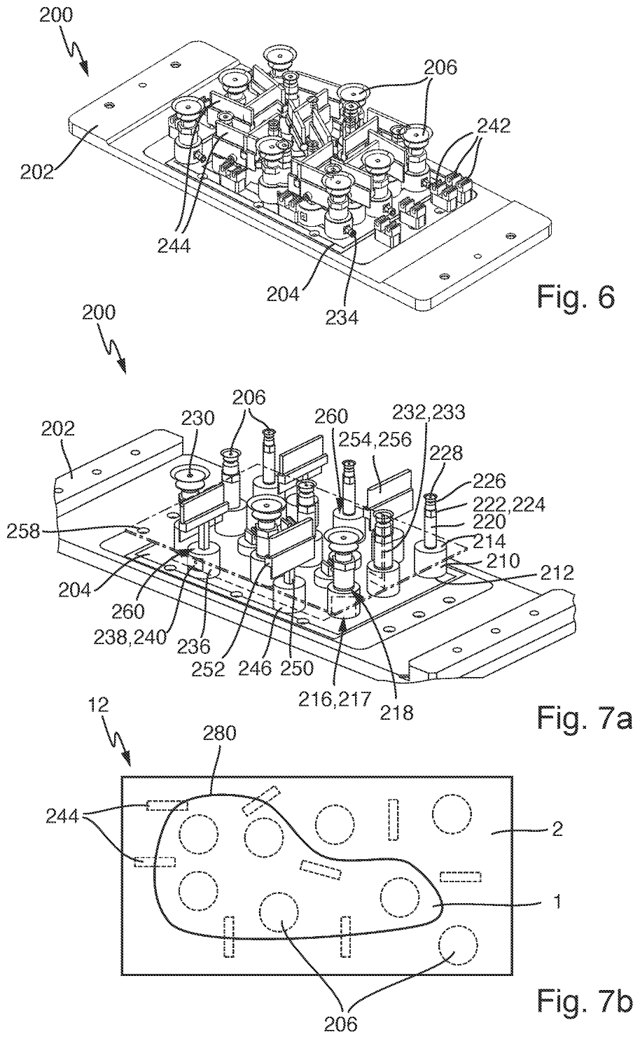

The corresponding holding device 200 in accordance with FIGS. 6 and 7 forms a bottom 32 of the associated magazine space 24, 26. The clamping device 400 is arranged along the x-axis laterally at the magazine space 24, 26 and thus forms a lateral edge region 34 of the associated magazine space 24, 26.

In accordance with FIGS. 6 and 7, the holding device 200 has a base plate 202 and a work plate 204 arranged in the base plate 202. The work plate 204 comprises a ferromagnetic material, preferably iron. The base plate 202 and/or the work plate 204 preferably have the outer dimensions of the flat material 12 to be processed along the x-axis and the y-axis. A plurality of magnetic vacuum devices 206 are provided on the work plate 204.

In accordance with FIGS. 6 and 7, the vacuum devices 206 are preferably designed to be circular-cylindrical, extend along the z-axis and each have a base 210 with a base underside 212 and a base upper side 214. A magnet holder 216 for releasably receiving a permanent magnet 217 is provided on the base underside 212. By means of the permanent magnet 217, the vacuum device 206 can be arranged and fastened as desired on the work plate 204, wherein the ferromagnetic material in the work plate 204 interacts with the permanent magnet 217. At the base upper side 214, the base 210 has an adapter holder 218 for releasably receiving an adapter piece 220. On an adapter upper side 222 opposite the adapter holder 218, the adapter piece 220 has a nozzle interface 224 for connecting a nozzle head 226. Depending on the nozzle head 226, a different size of the adapter piece 220 can be selected. The nozzle head 226 has a line outlet 230 on a nozzle upper side 228 opposite the adapter piece 220.

The base 210, the adapter piece 220 and the nozzle head 226 each have a cavity 232 in the interior, which cavity forms a line 233. The line 233 fluidically connects a line input 234 arranged at the base 210 to the line output 230. The base 210 has a line recess 238 with a flat recess bottom 240 in a base lateral surface 236 running parallel to the z-axis. Accordingly, the line inlet 234 is arranged on a flat recess bottom 240.

A vacuum supply (not shown) can be connected to the line input 234. In order to connect the vacuum supply to the vacuum devices 206, line hoses (not shown) can be used, wherein hose clamps 242 are provided for fastening the line hoses to the base plate 202 and/or the work plate 204. The hose clamps 242 can be screwed into prefabricated bores on the base plate 202 or can be arranged and fastened as desired on the work plate 204 by means of a permanent magnet (not shown), analogously to the vacuum device 206. By means of the vacuum supply and the line 233, a vacuum can be formed at the line output 230, by means of which vacuum the flat material 12 placed on the holding device 200 can be suctioned and held.

To improve the holding capability of the holding device 200, it is expedient to provide as many vacuum devices 206 as possible, so that both the flat material 12 and the cut piece 1 can be held securely. However, this is opposed by the fact that the flat material 12 is processed by means of a laser and the vacuum devices 206 are worn by the laser. For this reason, a plurality of magnetic support modules 244 are provided in addition to the vacuum devices 206. The support modules 244 serve as wear parts. The support modules 244 have a module base 246, a module web 250 arranged on the module base 246, and a brush holder 252 arranged on the module web 250. The module base 246 is designed corresponding to the base 210 and also has a permanent magnet, so that the support modules 244 can be arranged as desired on the work plate 204.

The brush holder 252 extends along the x-axis or the y-axis and has a plurality of brush hairs 254, wherein the brush hairs 254 of a support module 244 form a brush 256. The brush 256 also extends along the x-axis or the y-axis, wherein the flat material 12 or the cut piece 1 can also be held by the brush 256. The brush 256 comprises a plurality of brush hairs 254, wherein the brush hairs 254 can come into contact with the laser beam. In this case, a few brush hairs 254 are destroyed, but the brush 256 in total does not lose the holding capability due to the further brush hairs 254. After several cutting operations, the brush 256 can be replaced easily, inexpensively and quickly. Accordingly, the vacuum devices 206 can be arranged on the work plate 204 such that they are not arranged in the path of the laser beam, and the support modules 244 are arranged such that they are arranged in the path of the laser beam. The combination of vacuum devices 206 and support modules 244 accordingly results in an optimal balance between holding capability and longevity of the holding device 200.

FIGS. 6 and 7 differ with respect to the number and arrangement of the vacuum devices 206, the support modules 244, and the hose clamps 242.

Furthermore, a movement path 280 of a laser beam is shown in FIG. 7a, which movement path also corresponds to the outer contour of a cut piece 1. Furthermore, vacuum devices 206 and support modules 244 are shown in dashed lines. It can be seen that the movement path 280 of the laser beam does not cross the vacuum device 206, but can cross the support modules 244. Due to the distribution, it is ensured that, before the cut, the flat material 12 and, after the cut, the cut piece 1 and the waste 2 are securely held by means of the holding device 200.

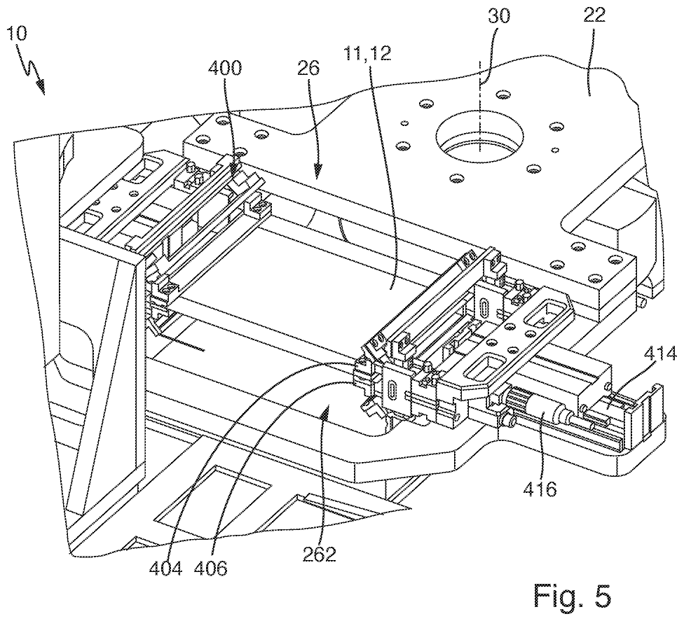

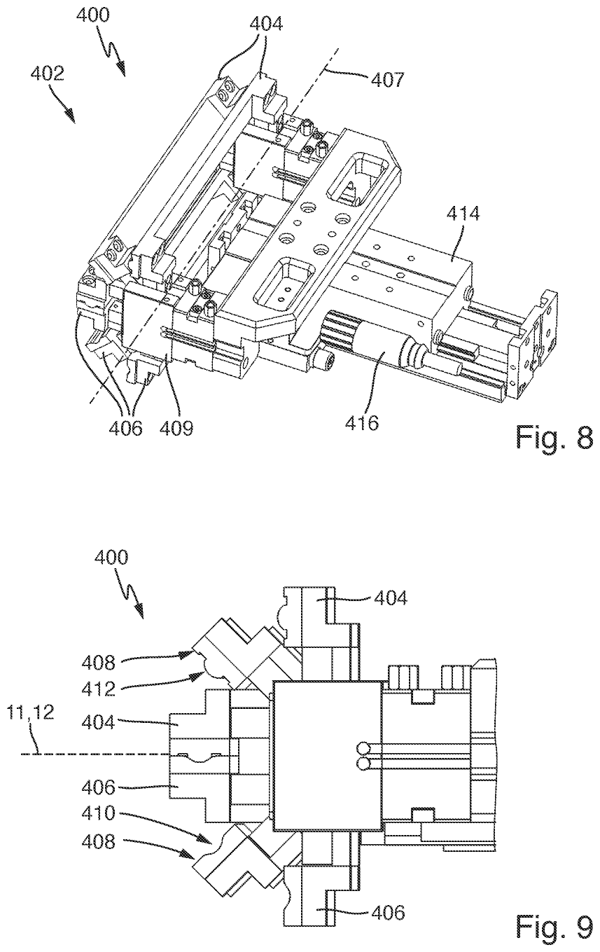

In accordance with FIGS. 5, 8 and 9, the clamping device 400 comprises two opposite pairs of clamping jaws 402, each pair of clamping jaws 402 having an upper clamping jaw 404 and a lower clamping jaw 406. The upper clamping jaw 404 and the lower clamping jaw 406 can each be displaced rotatably about a common clamping rotational axis 407 between an open position and a closed position by means of a clamping rotation drive 409 in each case. In the open position, a flat material 12 can be inserted into the clamping device 400 and, in the closed position, the flat material 12 is fixed and clamped in the clamping device 400. FIGS. 8 and 9 show the open position (parallel to the z-axis), the closed position (parallel to the x-axis) and an intermediate position (45° with respect to the x-axis) of the clamping jaws 404, 406, wherein the upper clamping jaw 404 pivots upwards into the open position and the lower clamping jaw 406 pivots downwards into the open position.

In order to realize the clamping of the flat material 12, each one clamping jaw 404, 406 has, in accordance with FIG. 9, a clamping surface 408 with a surface recess 410 and each other clamping jaw 404, 406 has a clamping element 412 projecting relative to the clamping surface 408. In the closed position, the clamping element 412 is at least partially accommodated by the surface recess 410. The surface recess 410 is preferably designed to be (concavely) complementary to the (convex) clamping element 412. Due to the longer path traveled by the flat material 12 while being fastened in place in the clamping device 400, the flat material 12 is simultaneously clamped for processing while being fastened in place.

In addition, the clamping device 400 in accordance with FIG. 8 can be designed to be displaceable along a clamping linear axis 414 by means of a clamping linear drive 416 between a near position and a remote position. In the near position, the pair of clamping jaws 402 are displaced toward the flat material 12 in order to reduce the tension of the flat material 12 being fastened in place. In the remote position, the pair of clamping jaws 402 are displaced away from the flat material 12 in order to increase the tension of the flat material 12 being fastened in place.

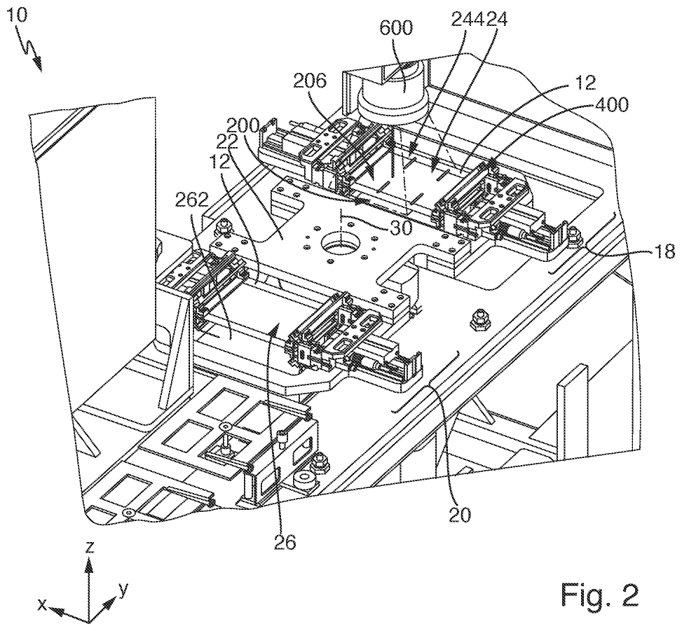

In the processing region 18, in accordance with FIGS. 1 and 2, the processing device 10 has a laser device 600. The laser device 600 is configured such that a laser beam emitted by the laser device 600 and running substantially parallel to the z-axis is directed onto the flat material 12, and an energy input into the flat material 12 occurs at an impingement point, so that the flat material can be cut into a cut piece 1 and waste 2 at the impingement point. The cut piece 1 is the product to be ultimately produced. The laser beam can preferably be moved over a working region, wherein the working region substantially corresponds to the longitudinal and transverse extent of the flat material 12. The laser device 600 preferably has an axis system 602 for displacing the laser beam along the x-axis by means of a first linear axis 604 and along the y-axis by means of a second linear axis 606. It is also conceivable for the axis system 602 to have a third linear axis (not shown) for displacing along the z-axis.

To improve safety, the holding device 200 in accordance with FIG. 7 can have a protective plate 258. The protective plate 258 serves to protect the holding device 200 from the laser beam. The protective plate 258 can preferably be arranged on the vacuum devices 206 and/or the support modules 244.

The protective plate 258 preferably has a grid with grid recesses 260, wherein the vacuum devices 206 and/or the support modules 244 can be arranged in the grid recesses 260. The protective plate 258 can be prefabricated, and the vacuum devices 206 and/or the support modules 244 can then be positioned on the work plate 204 at the grid recesses 260. The grid recesses 260 can correspond to the outer contour of the base 210 and module base 246 or the outer contour of the adapter pieces 220 and module webs 250. The protective plate 258 can preferably be supported on the base 210 and the module base 246 and is thus arranged at a distance from the work plate 204.

To provide the flat material 12 and to remove the cut piece 1 in the loading area 20 and to remove the waste 2 in the loading area 20, the processing device 10 has a transport device 800. In accordance with FIG. 1, the processing device 800 has a first handling device 802 with a first vacuum gripping tool 804. By means of a vacuum, the flat material 12 is held by suction onto the first handling device 802 and placed on the holding device 200.

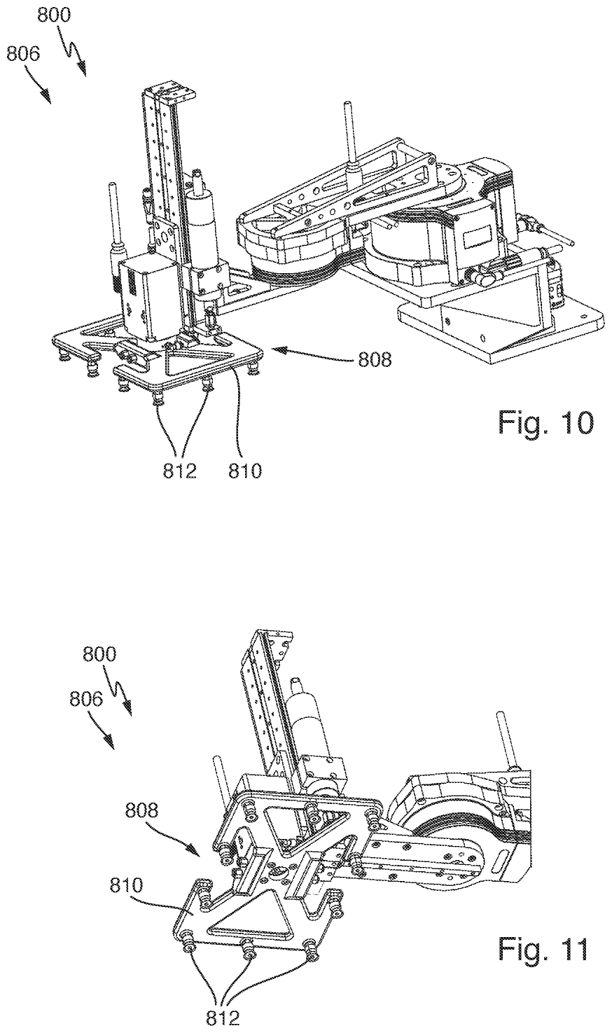

After the laser cutting of the flat material 12 in the processing region 18, the magazine 22 is rotated so that the processed flat material 12, in particular the cut piece 1 and the remaining waste 2 that are separated from one another, is moved into the loading region 20. To remove the waste from the loading area 20, the transport device 800 has a second handling device 806 with a second vacuum gripping tool 808 in accordance with FIGS. 10 and 11. By means of a vacuum, the flat material 12 is held by suction onto the second handling device 806 and is thus removed from the holding device 200 in the loading region 20. For this purpose, the second vacuum gripping tool 808 has a pressure distribution plate 810 and handling elements 812 arranged on the pressure distribution plate 801, in particular in the form of nozzles. The handling elements 812 are arranged such that the handling elements 812 only grip the waste. For this purpose, the handling elements 812 are arranged along the outer contour of the pressure distribution plate 810. The at least one cut piece 1 thus remains on the holding device 200. As soon as the waste is gripped by the second handling device 806, the clamping device 400 can be displaced into the release position.

A container 262 for receiving the waste 2 is also arranged below the loading region 20.

Only the cut piece 1 remains on the holding device 200, so that the cut piece 1 can be removed by means of the first handling device 802.

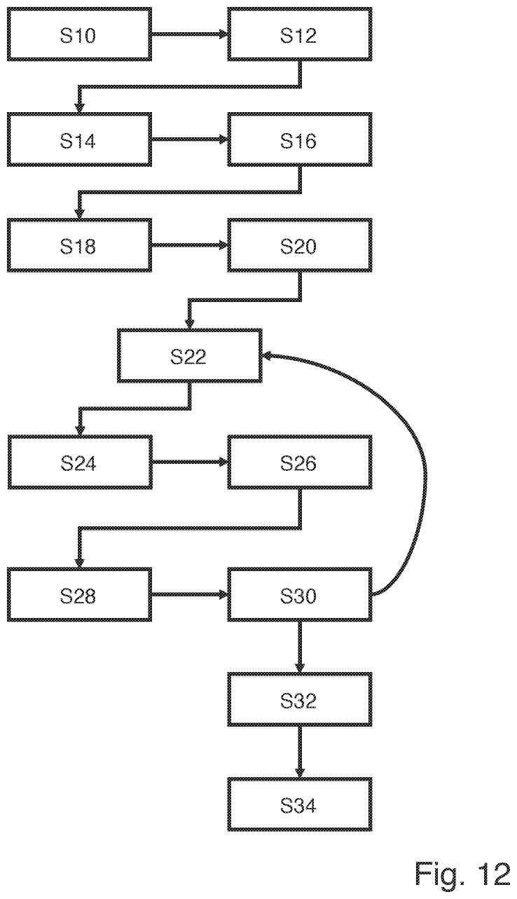

Furthermore, the method for operating the processing device 10 is described below with reference to FIG. 12.

Information about properties of the flat material 12 and the outer contour of the cut pieces 1 is provided to the processing device 10 (S10). Furthermore, a protective plate 258 without grid recesses 260 is preferably provided in the processing region 18 (S12). The processing device 10 preferably has a controller 13 and a memory 15 in order, among other things, to determine and store the movement path 280 of the laser beam (S14). Depending on the movement path 280 of the laser beam, the position of the vacuum devices 206 and/or of the support modules 244 is preferably determined, wherein, on the one hand, the flat material 12 and the at least one cut piece 1 should be held securely and, on the other hand, the movement path 280 should not run along the vacuum devices 206 (S16). At the determined positions of the vacuum devices 206 and/or of the support modules 244, grid recesses 260 are preferably incorporated into the protective plate 258 by means of the laser device 600 (S18). By means of the grid recesses 260, the vacuum devices 206 and/or the support modules 244 can be manually positioned. Alternatively, it is conceivable that the transport device 800 can set the vacuum devices 206 and/or the support modules 244 on the work plate 204 (S20).

Subsequently, a flat material 12 to be processed is placed onto the holding device 200 of the magazine space 24, 26 by means of the first handling device 802, which holding device is arranged in the loading position (S22). The flat material 12 placed on the holding device 200 is gripped, fastened in place and simultaneously clamped by the clamping device 400 (S24). The magazine 22 is then pivoted so that the loaded magazine space 24, 26 is brought into the processing region 18 with the clamped flat material 12 (S26).

The laser device 600 can now generate a laser beam which moves along the predetermined movement path 280. When the laser cutting is complete, the at least one cut piece 1 is separated from the waste 2 of the flat material 12 (S28). During the laser cutting, a processed flat material 12 can simultaneously be removed at the opposite magazine space 24, 26 and a further flat material 12 to be processed can be provided (S30).

After a further rotation of the magazine 22, the flat material 12 to be processed is pivoted into the processing region 18 and the processed flat material is pivoted in the loading region 20. While the further flat material 12 is laser cut in the processing region 18 (S28), the processed flat material 12 can be removed so that the magazine space 24, 26 can be fitted with a new flat material 12 (S30). For this purpose, the waste 2 is first removed by means of the second handling device 806 and placed in the container 262 (S32). It is conceivable that, in order to place the waste into the container 262, the magazine spaces 24, 26 must be in an intermediate position in order to expose the container 262. Subsequently, the cut piece 1 is removed by means of the first handling device 802 and transported to the next production site (S34).

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

### LIST OF REFERENCE NUMBERS

X X-axis
Y Y-axis
Z Z-axis
1 Cut piece
2 Waste
10 Processing device
11 Material plane
12 Flat material
13 Controller
14 Device housing
15 Memory
16 Control cabinet
18 Processing region
20 Loading region
22 Magazine
24 First magazine space
26 Second magazine space
28 Rotary drive
30 Magazine axis
32 Bottom
34 Edge region
200 Holding device
202 Base plate
204 Work plate
206 Vacuum device
210 Base
212 Base underside
214 Base upper side
216 Magnet holder
217 Permanent magnet
218 Adapter holder
220 Adapter piece
222 Adapter upper side
224 Nozzle interface
226 Nozzle head
258 Protective plate
228 Nozzle upper side
230 Line output
232 Cavity
233 Line
234 Line input
236 Base lateral surface
238 Line recess
240 Recess bottom
242 Hose clamp
244 Support module
246 Module base
250 Module web
252 Brush holder
254 Brush hairs
256 Brush
260 Grid recess
262 Container
280 Movement path
400 Clamping device
402 Pair of clamping jaws
404 First clamping jaw
406 Second clamping jaw
407 Clamping rotational axis
408 Clamping surface
409 Clamping rotary drive
410 Surface recess
412 Clamping element
414 Clamping linear axis
416 Clamping linear drive
600 Laser device
602 Axis system
604 Linear axis
800 Transport device
802 First handling device
804 First gripping tool
806 Second handling device
808 Second gripping tool
810 Pressure distribution plate
812 Handling element

What is claimed is:

1. A processing device (10) for processing flat material (12) extending along a material plane (11), the processing device (10) comprising:
at least one holding device (200) for holding the flat material (12),
at least one clamping device (400) for fastening the flat material (12) in place and for clamping the flat material (12) along the material plane (11),
at least one laser device (600) for cutting at least one cut piece (1) from the flat material (12),
wherein the holding device (200) is designed such that, after the laser cut, the at least one cut piece (1) is held by the holding device (200).

2. The processing device (10) according to claim 1, wherein the holding device (200) is designed as a vacuum holding device (200) for holding the flat material (12) by suction.

3. The processing device (10) according to claim 1, wherein the clamping device (400) has at least two opposite pairs of clamping jaws (22) for fastening in place and/or for clamping in each case one side of the flat material (12).

4. The processing device (10) according to claim 1, wherein the laser device (600) can be displaced at least along an x-axis (X) and a y-axis (Y), wherein the x-axis (X) and the y-axis (Y) run parallel to the material plane (11) in the state in which the flat material (12) is fastened in place.

5. The processing device (10) according to claim 1, wherein a transport device (800) for providing the flat material (12) on the holding device (200) and/or clamping device (400) and/or for removing the cut piece (1) and/or the waste (2) from the holding device (200) and/or clamping device (400) is provided.

6. The processing device (10) according to claim 5, wherein the transport device (800) has a first handling device (802) for placing the flat material (12) onto the holding device (200) and/or for removing the at least one cut piece (1) from the holding device (200).

7. The processing device (10) according to claim 5, wherein the transport device (800) has a second handling device (806) for removing the waste (2) of the flat material (12) from the holding device (200).

8. The processing device (10) according to claim 7, wherein the second handling device (806) has handling elements (812), wherein the handling elements (812) are arranged such that the handling elements (812) grip the waste (2) and not the at least one cut piece (1).

9. The processing device (10) according to claim 1, wherein a magazine (22) is provided with magazine spaces (24, 26), wherein each magazine space (24, 26) has a clamping device (400) and in particular a holding device (200).

10. The processing device (10) according to claim 9, wherein the magazine (22) can be rotated about a magazine axis (30) such that the magazine spaces (24, 26) can be arranged in at least one processing position and in at least one loading position, wherein a first magazine space (24) is arranged below the laser device (600) in the processing position.

11. The processing device (10) according to claim 10, wherein a second magazine space (26) is provided in the loading position above a container (262) for receiving the waste (2) of the flat material (12).

12. A method for processing flat material (12) extending along a material plane (11), comprising the following:
a) Holding at least one flat material (12) by a holding device (200);
b) Clamping the flat material (12) along the material plane (11) by a clamping device (400);
c) Cutting at least one cut piece (1) from the flat material (12) with a laser beam, wherein, during and after the laser cutting, waste (2) of the flat material is fastened in place and clamped by the clamping device (400), and wherein, after the laser cutting, at least the at least one cut piece (1) is held by the holding device (200).

13. The method according to claim 12, wherein the flat material (12) and/or the cut piece (1) is held by a vacuum.

14. The method according to claim 12, wherein the flat material (12) is released from the holding device (200) with the clamping.

15. The method according to claim 12, wherein, after the cut piece (1) has been cut from the flat material (12), the cut piece (1) is gripped and removed by a first handling device (802).

16. The method according to claim 12, wherein, after the cut piece has been cut from the flat material (12), the waste (2) of the flat material (12) is released and is gripped and removed by a second handling device (806).

17. The method according to claim 12, wherein, after the cut piece (1) has been cut from the flat material (12), first the waste (2) and then the cut piece (1) are gripped and removed.

18. The method according to claim 12 wherein the method is performed by a processing device (10).
